(19) United States
(12) Patent Application Publication
(10) Pub. No.: US 2016/0176340 A1
(43) Pub. Date: Jun. 23, 2016

(54) PERSPECTIVE SHIFTING PARKING CAMERA SYSTEM

(71) Applicant: Continental Automotive Systems, Inc., Auburn Hills, MI (US)

(72) Inventor: John A. Maxwell, Cary, IL (US)

(21) Appl. No.: 14/573,772

(22) Filed: Dec. 17, 2014

(51) Int. Cl. B60R 1/00; G01B 17/00; G06T 15/20; B60R 11/04

(52) U.S. Cl. CPC B60R 1/00; B60R 11/04; G01B 17/00; G06T 15/205; B60R 2011/004

(57) ABSTRACT

Parking assistance is provided to a driver by shifting the viewing perspective of cameras attached to the vehicle. Shifting the perspective is accomplished by capturing images of objects adjacent the vehicle to be parked, determining distances between the vehicle and objects adjacent the vehicle, creating a three-dimensional map of objects adjacent the vehicle, overlaying images of objects adjacent the vehicle onto the three-dimensional map, and creating a virtual three-dimensional representation of objects adjacent the vehicle.

### BACKGROUND

Parking a vehicle is a challenge for some drivers. Some vehicle manufacturers provide rear-facing cameras, which can help with parking but their true value is limited primarily because they do not provide a spatial point of reference. Stated another way, they do not provide a perspective of objects adjacent the vehicle, which often make it difficult to park a car. A method and apparatus for assisting a driver with parking a car would be an improvement over the prior art.

### BRIEF SUMMARY

In accordance with embodiments of the invention, parking assistance is provided to a driver by shifting the viewing perspective of cameras attached to the vehicle. Shifting the perspective is accomplished by capturing images of objects adjacent the vehicle to be parked, determining distances between the vehicle and objects adjacent the vehicle, creating a three-dimensional map of objects adjacent the vehicle, overlaying images of objects adjacent the vehicle onto the three-dimensional map, and creating a virtual three-dimensional representation of objects adjacent the vehicle.

### BRIEF DESCRIPTION OF THE DRAWINGS

FIG. 1 is a side view of a vehicle, namely an automobile;

FIG. 2 is a top view of the vehicle shown in FIG. 1;

FIG. 3 is a block diagram of an apparatus for providing shifted perspective parking assistance;

FIG. 4 is an illustration of a shifted perspective to two vehicles adjacent to each other; and

FIG. 5 is a block diagram showing steps of a method for shifting the perspective of a parking camera.

### DETAILED DESCRIPTION

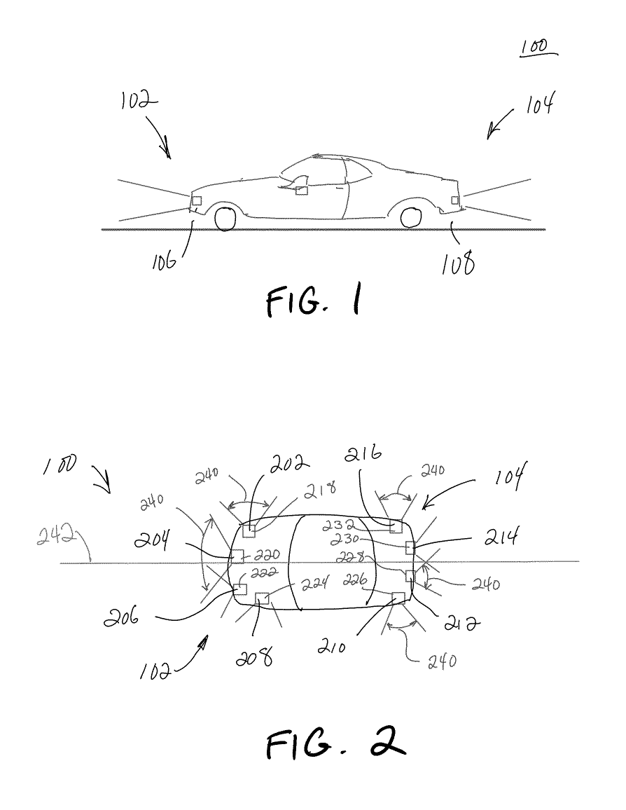

FIG. 1 is a side view of a vehicle 100. The vehicle 100 has a front end 102 and a rear end 104. It also has a front bumper 106 and a rear bumper 108.

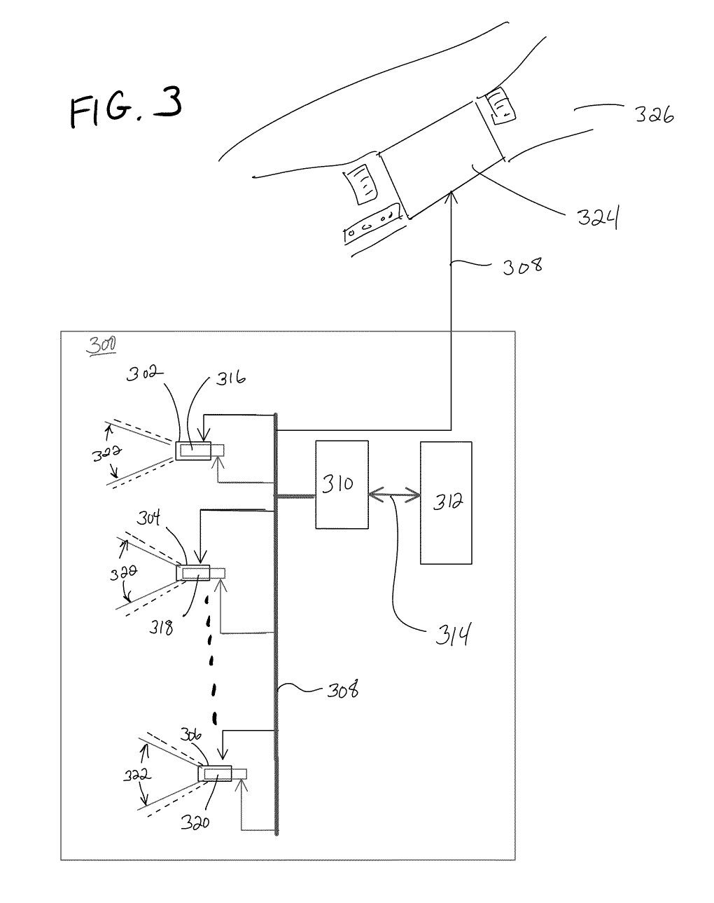

FIG. 2 is a top or plan view of the automobile 100 shown in FIG. 1. The front end 102 of the vehicle 100 has several cameras 202, 204, 206 and 208. The rear end 104 of the vehicle 104 is also provided with several cameras 210, 212, 214 and 216.

As used herein, the term “field of view” refers to an area or region captured by an imager in each camera. Each camera has a field of view 240. The combined fields of view of the cameras at the front 102 subtend an angle of about one-hundred eighty degrees relative to a longitudinal axis 242, as do the cameras at the rear 104. The cameras thus capture images of objects around or adjacent the vehicle, specifically including objects in front of and behind the vehicle.

As is well known, many cameras employ an ultrasonic distance sensor to focus the camera lens and adjust a flash unit. In a preferred embodiment each camera 202, 204, 206, 208 attached to the front 102 of the vehicle 100 is provided with a corresponding ultrasonic distance sensor 218, 220, 222 and 224. The cameras 210, 212, 214 and 216 at the rear end 104 are also provided with corresponding ultrasonic distance sensors 226, 228, 230 and 232.

The distance sensors determine and provide a measurement of the distance between themselves and an object within a field of view 240 of a corresponding camera. In other words, a first camera 202, at the right front of the vehicle 102 has a distance sensor 218, which determines distances between the distance sensor 218 or camera 202 and objects within the field of view 240 of the camera 202. Similarly, the camera 210 at the left rear bumper of the vehicle has a distance sensor 226, which determines distances between the distance sensor 226 and camera 210 and objects within the field of view 240 of the camera 210. Together, the distance sensors determine distances between the vehicle 100 and objects around, i.e. adjacent, the vehicle 100.

As used herein, the term, “adjacent” means mean in close proximity to. An object is or can be adjacent to a vehicle to be parked, if the object is in front of, behind, next to, or otherwise in close proximity, such that the separation distance between the object or a portion or surface thereof, and a vehicle to be parked is less than about ten feet up to as much as about twenty to thirty feet, depending on the size of the vehicle to be parked.

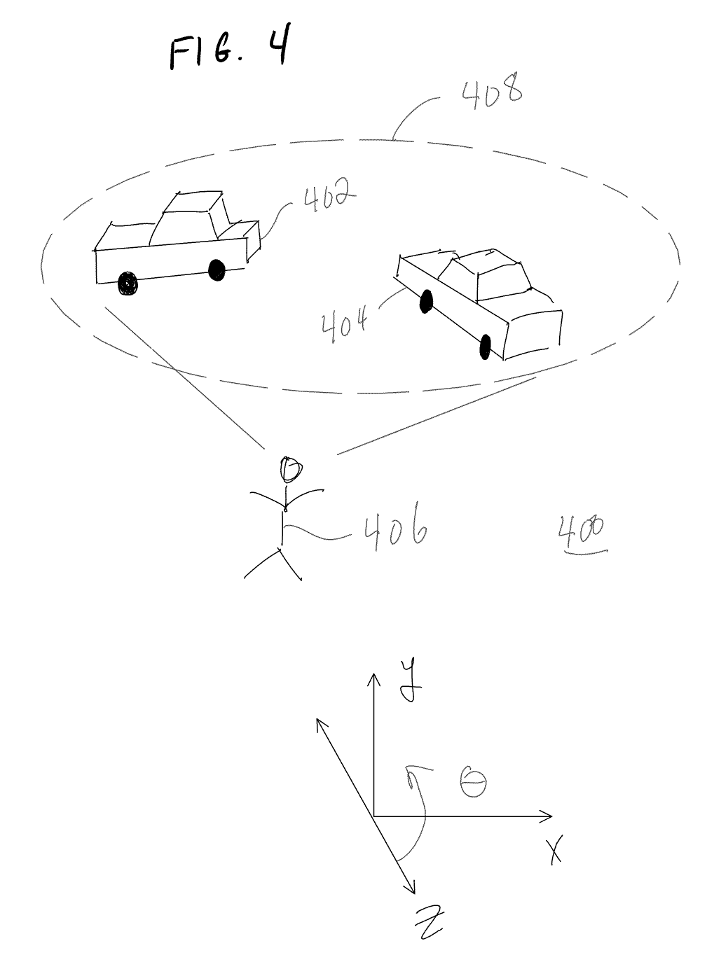

As used herein, “perspective” refers to the appearance of objects in respect to their relative distances from each other and their positions, relative to each other. FIG. 3 is a block diagram of an apparatus 300 for providing parking assistance by shifting the perspective of the cameras 202-216 and for providing on a display device, one or more images representing a view of the vehicle from the perspective of an object around the vehicle, i.e., adjacent to the vehicle, an image of which is captured by a camera, the distance from the vehicle of which is measured by a distance sensor. The terms, “around” and “adjacent” are used interchangeably hereinafter.

As used herein, the term “bus” refers to a set of electrically-parallel conductors in a computer system and which form a main transmission path for components of the computer system. The system 300 in FIG. 3 comprises multiple cameras 302, 304 and 306 each of which is coupled to a bus 308 preferably embodied as a controller area network or “CAN” bus that couples the cameras to a controller 310, i.e., a processor 310. The cameras 302, 304 and 306 capture images of objects within their corresponding fields of view 322 responsive to commands that they receive from the controller 310. The cameras, which are digital, provide data via the bus 308 to the controller 310, which represent captured images of objects within the corresponding fields of view. By virtue of the placement of the cameras on the vehicle, the cameras are thus able to capture images of objects around the vehicle.

The system 300 additionally comprises a distance sensor associated with each camera. The distance sensors 316, 318 and 320 ultrasonically measure or determine distances between themselves, each of which is attached to the vehicle, and objects within the fields-of-view 322 of the corresponding cameras.

The ultrasonic distance sensors 316, 318 and 320 are also coupled to the controller 310 via the same bus 308. The distance sensors, by virtue of their physical and operational association with cameras, determine distances between objects around the vehicle and are able to thus create a three-dimensional mapping of objects around the vehicle. The distance sensors are used to create a three-dimensional mapping of objects around the vehicle and their locations from the vehicle.

The controller 310 is coupled to a non-transitory memory device 312 through a second bus 314, commonly referred to as an address/control/data bus, commonly used in microcontroller and microprocessor computer based systems. Program instructions in the non-transitory memory device 312 cause the processor to overlay the locations of the objects around the vehicle onto the images of objects captured by the cameras 302, 304 and 306 and thus create a virtual three-dimensional representation of objects around the vehicle 100.

Program instructions in the memory device 312 cause the processor 310 to “create an image” of the virtual three-dimensional representation of objects around the vehicle. That image is displayed on a touch-sensitive display device 324 located in the control panel or dashboard 326 of the vehicle 100, which is omitted from FIG. 3 for brevity and clarity. The image displayed on the display device 324 is thus an image of objects around the vehicle 100 that a person would see when the vehicle 100 is viewed from the perspective of one of the objects detected by the distance sensors and “seen” by a corresponding camera.

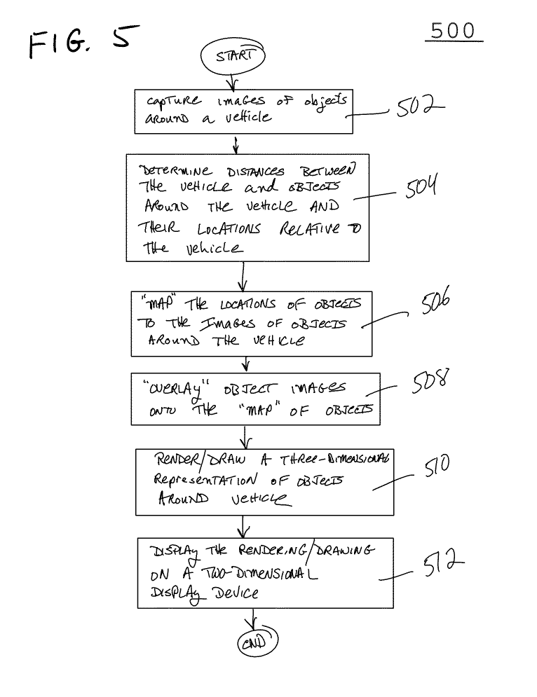

FIG. 4 illustrates a shifted perspective view 400 of a vehicle to be parked 402 and which is in front of a vehicle that is already parked and stationary 404. The second vehicle 404 is also an object that is around, i.e., adjacent to, the vehicle 402 to be parked. Cameras and distance sensors on the first vehicle 402 detect an object 406 away from the vehicle 402 and project on a display device an image of the two vehicles. The view of the two vehicles is shifted in space to a point in an x-y plane and with a horizontal rotation angle, Θ.

The ability to provide an image of objects adjacent to the vehicle 100 inherently requires a three-dimensional model of surfaces and dimensions of the vehicle 100 to which the cameras and distance sensors are attached. Knowing those dimensions and surface models enables the controller 310 to render on the display device 324 a virtual image of the vehicle 100 on the display device that appears to be a three-dimensional model. The rendering of a second vehicle on the display device 324 is facilitated by models of surfaces of generic vehicle characteristics, selected by the controller 310 responsive to program instructions stored in the non-transitory memory device 312.

FIG. 5 depicts steps of a method of providing vehicle parking assistance. More particularly, FIG. 5 depicts steps of a method to shift the perspective of a parking camera.

As a first step 502, the method requires the capture of images of objects around or adjacent a vehicle, using an apparatus such as the one described above. Those of ordinary skill in the art will recognize the necessity of limiting the distance or range of objects images of which are to be captured. By way of example, images that are more than 3-10 feet from the front and rear bumpers, are ignored.

At step 504, the actual distances between the vehicle surfaces and objects around the vehicle and in the field of view of a camera are determined using ultrasonic distance sensors. Once those distances are determined, the locations of those objects around the vehicle are “mapped” in step 506 by their spatial coordinates. The spatial coordinates are x and y coordinates in a horizontal plane in which the vehicle lies.

At step 508, the images of objects captured by the cameras are overlaid onto the map or the locations of those objects detected by the ultrasonic sensors. At step 510, a rendering or drawing of a three-dimensional representation of those objects in space is prepared and at step 512, the three-dimensional rendering is displayed on a two-dimensional display device. The image displayed on the display device is a view of the vehicle from the perspective of a point in an x-y coordinate plane, in which the vehicle lies, with a specified horizontal rotation angle, from the perspective of that point in space the result of which is a shifted perspective of the vehicle to be parked as shown in FIG. 4.

As used herein, the term “real time” refers to an actual time during which something takes place. Those of ordinary skill in the art will recognize the importance of rendering a shifted perspective of a parking camera in real time. The method described above and the apparatus depicted in FIG. 3 thus provide a real-time rendering of a parked object and a vehicle to be parked viewed from the perspective of a point located in an x-y coordinate plane in which the vehicle lies with a horizontal rotation angle that enables or provides on an instrument-panel mounted display device, a view of objects in front of and behind a vehicle to be parked.

The foregoing description is for purposes of illustration only. The true scope of the invention is set forth in the following claims.

1. An apparatus for providing vehicle parking assistance, the apparatus comprising:
a plurality of cameras attached to a first vehicle that is to be parked adjacent to a second vehicle that is already parked, the cameras being configured to capture images of objects adjacent the first vehicle and provide data representing captured images of objects adjacent the first vehicle; and
a distance sensor coupled to the cameras and configured to:
determine distances between the first vehicle and objects adjacent the first vehicle;
create a three-dimensional mapping of objects adjacent the first vehicle using determined distances between said objects adjacent the vehicle and the vehicle; and
overlay images of objects captured by the plurality of cameras onto the three-dimensional mapping of objects adjacent the vehicle; and
create a virtual three-dimensional representation of objects adjacent the vehicle.

2. The apparatus of claim 1, further comprising:
a display device within the vehicle;
a processor coupled to the display device, the plurality of cameras and the distance sensor; and
a non-transitory memory device coupled to the processor, the memory device storing a three-dimensional model of the vehicle, the memory device additionally storing program instructions, which when executed cause the processor to:
control the perspective inside the virtual three-dimensional representation of objects adjacent the vehicle based on coordinates in an X-Y coordinate plane and a horizontal rotation angle; and
create and display on the display device, an image representing a view of the vehicle from a perspective in the virtual three-dimensional mapping of objects adjacent the vehicle.

3. The apparatus of claim 1, wherein the stored program instructions cause the processor to create and display on the display device, an image representing the first vehicle and the second vehicle when both vehicles are viewed from a perspective of a point in an X-Y coordinate plane with a horizontal rotation angle.

4. The apparatus of claim 1, wherein the stored program instructions cause the processor to create and display in real time, an image on the display device that represents the first vehicle and the second vehicle, when both vehicles are viewed from a perspective of an object adjacent the vehicle, said image on the display device changing in real time with real-time changes of a location of the first vehicle relative to the second vehicle and real-time changes of a perspective relative to objects in the virtual three-dimensional representation.

5. The apparatus of claim 1, wherein the stored program instructions cause the processor to create and display in real time, an image representing a view of the vehicle from the perspective of a location in a virtual space having coordinates along an x-axis, a y-axis and an independent rotational axis, the x, y and rotation axes being adjusted by the stored program instructions to change the perspective of the camera.

6. The apparatus of claim 1, wherein the distance sensor comprises an ultrasonic range finder.

7. The apparatus of claim 1, wherein the distance sensor is configured to determine distances between the first vehicle and the second parked vehicle.

8. The apparatus of claim 1, wherein the distance sensor is configured to determine distances between the first vehicle, the second parked vehicle and other objects in a field of view of a camera.

9. The apparatus of claim 8, wherein the distance sensor is configured to determine distances less than about thirty feet.

10. The apparatus of claim 1, wherein the three-dimensional model of the vehicle comprises a plurality of three-dimensional models of surfaces and dimensions of the first vehicle.

11. The apparatus of claim 1, wherein the vehicle has front and rear bumpers and wherein the plurality of cameras are attached to the vehicle bumpers at spaced-apart intervals.

12. A method of providing vehicle parking assistance, the method comprising:
capturing images of objects adjacent a first vehicle that is to be parked and provide data representing captured images of objects adjacent the first vehicle;
determining distances between the first vehicle and objects adjacent the first vehicle;
creating a three-dimensional mapping of objects adjacent the first vehicle using determined distances between said objects adjacent the vehicle and the vehicle;
overlaying images of objects captured by the plurality of cameras onto the three-dimensional mapping of objects adjacent the vehicle; and
creating a virtual three-dimensional representation of objects adjacent the vehicle.

13. The method of claim 9, further comprising: creating and displaying on a display device, an image representing a view of the vehicle from the perspective of a location in a virtual space having coordinates along an x-axis, a y-axis and an independent rotational axis, the x, y and rotation axes being adjustable to change the perspective of the camera.
